(19) United States
(12) Patent Application Publication
(10) Pub. No.: US 2022/0237902 A1
(43) Pub. Date: Jul. 28, 2022

(54) CONVERSION DEVICE, CONVERSION LEARNING DEVICE, CONVERSION METHOD, CONVERSION LEARNING METHOD, CONVERSION PROGRAM, AND CONVERSION LEARNING PROGRAM

(71) Applicant: NIPPON TELEGRAPH AND TELEPHONE CORPORATION, Tokyo (JP)

(72) Inventors: Kaori KUMAGAI, Tokyo (JP); Yukito WATANABE, Tokyo (JP); Jun SHIMAMURA, Tokyo (JP); Atsushi SAGATA, Tokyo (JP)

(73) Assignee: NIPPON TELEGRAPH AND TELEPHONE CORPORATION, Tokyo (JP)

(21) Appl. No.: 17/619,217

(22) PCT Filed: Jun. 17, 2019
(86) PCT No.: PCT/JP2019/023974

§ 371 Date: Dec. 14, 2021

(51) Int. Cl. G06V 10/774; G06T 7/70; G06V 10/40; G06V 10/776; G06V 20/00; G06T 11/00

(52) U.S. Cl. CPC G06V 10/7747; G06T 7/70; G06V 10/40; G06T 2207/20084; G06V 20/95; G06T 11/00; G06T 2207/20081; G06V 10/776

(57) ABSTRACT

A conversion apparatus includes: an input unit which receives an image for conversion; a mask generation unit which uses the image as an input to an identifier trained in advance and stored in a storage unit and generates a target attribute mask representing an attribute desired to be assigned to each position of a converted image of the image and an attribute degree of the converted image according to an output from the identifier; and an image conversion unit which uses the image and the target attribute mask as inputs to a converter trained in advance and stored in the storage unit and generates a converted image according to an output from the converter, and the identifier and the converter are trained under various restrictions including restrictions with respect to attributes.

### TECHNICAL FIELD

The disclosed technology relates to a conversion apparatus, a conversion learning apparatus, a conversion method, a conversion learning method, a conversion program, and a conversion learning program.

### BACKGROUND ART

An object image conversion technology is a technology for converting only attributes of an object in an image such that they are like a genuine object image while maintaining inherent characteristics of the object and is a kind of image conversion technology. This technology is used for various image conversion tasks such as object style conversion and conversion of a human facial expression.

In NPL 1, a function of converting a source image into a converted image using conditional GAN in NPL 2 is trained. L1 loss between the source image and the converted image is calculated and learning is performed such that L1 loss is minimized. Accordingly, paired data in which attributes of only object regions are different is necessary for learning.

NPL 3 works on conversion under conditions in which the aforementioned paired data cannot be prepared. A reconstructed image is generated such that a converted image is returned to a source image, a reconstruction error that is a difference between the source image and the reconstructed image is calculated, and learning is performed such that the reconstruction error is minimized. By introducing the reconstruction error, conversion can be performed while maintaining a structure in an image even under conditions in which paired data cannot be prepared.

According to the above-described methods of NPL 1 and NPL 3, conversion between two attributes can be performed through a single model.

NPL 4 works on conversion between a plurality of attributes through a single model. To realize conversion between a plurality of attributes, it is identified whether a converted image has a desired attribute provided thereto before conversion using an attribute classifier, and conversion of an image such that it is identified as having a desired attribute is trained to enable conversion between a plurality of attributes.

### CITATION LIST

### Non Patent Literature

[NPL 1] Isola. Phillip, Zhu. Jun-Yan, Zhou. Tinghui, Efros. Alexei A. “Image-to-Image Translation with Conditional Adversarial Networks”, In Proc. Of CVPR, 2017.
[NPL 2] Mehdi. Mirza, Simon. Osindero. “Conditional Generative Adversarial Nets”, CoRR, 2014.
[NPL 3] Zhu. Jun-Yan, Park. Taesung, Isola. Phillip, Efros. Alexei A. “Unpaired Image-to-Image Translation using Cycle-Consistent Adversarial Networks”, In Proc. Of ICCV, 2017.
[NPL 4] Yunjey. Choi, MinJe. Choi, Munyoung. Kim, Jung. Woo. Ha, Sunghun. Kim, Jaegul. Choo. “StarGAN: Unified Generative Adversarial Networks for Multi-Domain Image-to-Image Translation”, In Proc of CVPR, 2018.

### SUMMARY OF THE INVENTION

### Technical Problem

All of the above-described conversion technologies require a large amount of images of an object that is a conversion target when a conversion model is trained. To overcome this restriction, a task of converting an unknown object that is not present in a learning image is undertaken.

Conventional technologies are established under the premise that an object present in an image that is a conversion target is present in a learning image, and a conversion region and a conversion degree are implicitly trained. Accordingly, a conversion region and a conversion degree of an image that is a conversion target can be appropriately predicted. However, when an image including an unknown object that is not present in a learning image is input, this premise is violated and an appropriate conversion region and conversion degree cannot be predicted, and thus a desired image cannot be obtained.

For example, when a “cap” is an unknown object that is not present in learning data, as illustrated in FIG. 7, a problem that a realistic image is not acquired occurs. For example, a conversion region of the unknown object is not ascertained and thus a background region can be converted. In addition, a conversion degree of the unknown object is not ascertained and thus an attribute degree can become constant. In this manner, it is difficult to identify the brim part and the hemispheric part of the cap.

An object of the disclosed technology devised in view of the aforementioned circumstances is to provide a conversion apparatus, a conversion learning apparatus, a conversion method, a conversion learning method, a conversion program, and a conversion learning program for appropriately converting even an image including an unknown object.

### Means for Solving the Problem

A first aspect of the present disclosure is a conversion apparatus including: an input unit which receives an image for conversion; a mask generation unit which uses the image as an input to an identifier trained in advance and stored in a storage unit and generates a target attribute mask representing an attribute desired to be assigned to each position of a converted image of the image and an attribute degree of the converted image according to an output from the identifier; and an image conversion unit which uses the image and the target attribute mask as inputs to a converter trained in advance and stored in the storage unit and generates a converted image according to an output from the converter, wherein the identifier and the converter are trained such that, on the basis of a learning image, a converted image converted from the learning image, an attribute mask generated from attribute position information representing an attribute of each position of the learning image, an original attribute mask having the same size as the attribute mask and representing the attribute of each position of the learning image and an attribute degree of the learning image, and the target attribute mask with respect to the learning image, parameters of the identifier are updated such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, with respect to the identifier in the storage unit, and parameters of the converter are updated such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, with respect to the converter in the storage unit.

A second aspect of the present disclosure is a conversion learning apparatus including: an input unit which receives a learning image and attribute position information representing an attribute of each position of the learning image; a mask generation unit which generates an attribute mask from the attribute position information, and generates an original attribute mask having the same size as the attribute mask and representing an attribute of each position of the learning image and an attribute degree of the learning image, and a target attribute mask representing an attribute desired to be assigned to each position of a converted image of the learning image and an attribute degree of the converted image on the basis of the attribute position information and an output from an identifier when the learning image has been input; an image conversion unit which uses the learning image and the target attribute mask as inputs to a converter and generates a converted image according to an output from the converter; and a parameter update unit which updates, with respect to the identifier, parameters of the identifier such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, and updates, with respect to the converter, parameters of the converter such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, on the basis of the learning image, the converted image, the attribute mask, the original attribute mask, and the target attribute mask.

A third aspect of the present disclosure is a conversion method of causing a computer to execute processing, including: receiving an image for conversion; using the image as an input to an identifier trained in advance and stored in a storage unit and generating a target attribute mask representing an attribute desired to be assigned to each position of a converted image of the image and an attribute degree of the converted image according to an output from the identifier; and using the image and the target attribute mask as inputs to a converter trained in advance and stored in the storage unit and generating a converted image according to an output from the converter, wherein the identifier and the converter are trained such that, on the basis of a learning image, a converted image converted from the learning image, an attribute mask generated from attribute position information representing an attribute of each position of the learning image, an original attribute mask having the same size as the attribute mask and representing the attribute of each position of the learning image and an attribute degree of the learning image, and the target attribute mask with respect to the learning image, parameters of the identifier are updated such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, with respect to the identifier in the storage unit, and parameters of the converter are updated such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, with respect to the converter in the storage unit.

A fourth aspect of the present disclosure is a conversion learning method of causing a computer to execute processing, including: receiving a learning image and attribute position information representing an attribute of each position of the learning image; generating an attribute mask from the attribute position information, and generating an original attribute mask having the same size as the attribute mask and representing an attribute of each position of the learning image and an attribute degree of the learning image, and a target attribute mask representing an attribute desired to be assigned to each position of a converted image of the learning image and an attribute degree of the converted image on the basis of the attribute position information and an output from an identifier when the learning image has been input; using the learning image and the target attribute mask as inputs to a converter and generating a converted image according to an output from the converter; and updating, with respect to the identifier, parameters of the identifier such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, and updating, with respect to the converter, parameters of the converter such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, on the basis of the learning image, the converted image, the attribute mask, the original attribute mask, and the target attribute mask.

A fifth aspect of the present disclosure is a conversion program causing a computer to execute the same processing as the conversion method of the third aspect.

A sixth aspect of the present disclosure is a conversion learning program causing a computer to execute the same processing as the conversion learning method of the fourth aspect.

### Effects of the Invention

According to the disclosed technology, it is possible to appropriately convert even an image including an unknown object.

### BRIEF DESCRIPTION OF DRAWINGS

FIG. 1 is a block diagram illustrating a configuration of a conversion learning apparatus of the present embodiment.

FIG. 2 is a block diagram illustrating a hardware configuration of the conversion learning apparatus and a conversion apparatus.

FIG. 3 is a block diagram illustrating a configuration of a conversion apparatus of the present embodiment.

FIG. 4 is a block diagram illustrating a configuration of a conversion learning apparatus of the present embodiment.

FIG. 5 is a flowchart illustrating a flow of conversion learning processing of the conversion learning apparatus.

FIG. 6 is a flowchart illustrating a flow of conversion processing of the conversion apparatus.

FIG. 7 is an image diagram of a problem generated in the case of an unknown object.

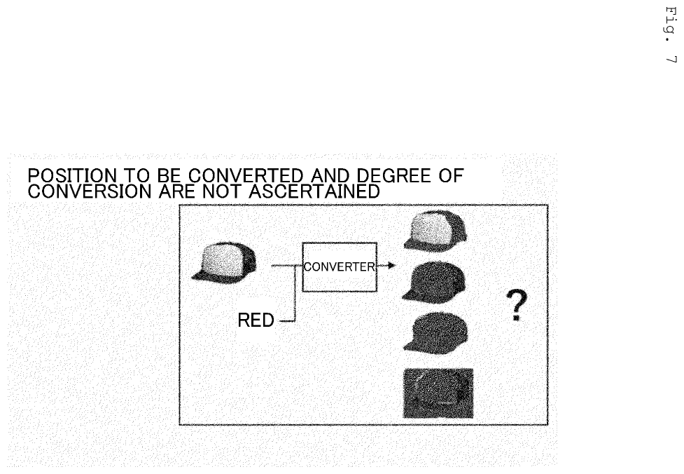

### DESCRIPTION OF EMBODIMENTS

Hereinafter, an example of an embodiment of the disclosed technology will be described with reference to the drawings. Meanwhile, the same or equivalent components and parts are denoted by the same reference signs in each drawing. In addition, a dimension ratio of drawings is exaggerated for convenience of description and may be different from an actual ratio.

Hereinafter, configurations of the present embodiment will be described.

<Configuration of Conversion Learning Apparatus>

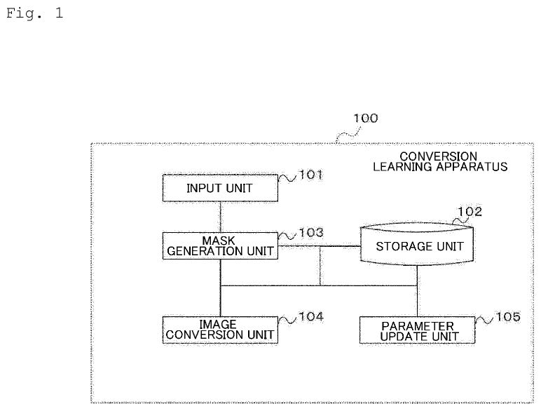

FIG. 1 is a block diagram illustrating a configuration of a conversion learning apparatus of the present embodiment.

As illustrated in FIG. 1, the conversion learning apparatus 100 includes an input unit 101, a storage unit 102, a mask generation unit 103, an image conversion unit 104, and a parameter update unit 105.

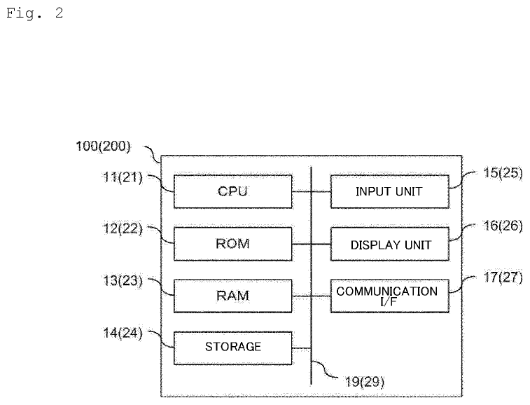

FIG. 2 is a block diagram illustrating a hardware configuration of the conversion learning apparatus 100.

As illustrated in FIG. 2, the conversion learning apparatus 100 includes a central processing unit (CPU) 11, a read only memory (ROM) 12, a random access memory (RAM) 13, a storage 14, an input unit 15, a display unit 16, and a communication interface (I/F) 17. The components are connected through a bus 19 such that they can communicate each other.

The CPU 11 is a central arithmetic processing unit and executes various programs and controls each component. That is, the CPU 11 reads a program from the ROM 12 or the storage 14 and executes the program using the RAM 13 as a working area. The CPU 11 performs control of the aforementioned components and various types of arithmetic processing according to a program stored in the ROM 12 or the storage 14. In the present embodiment, a conversion learning program is stored in the ROM 12 or the storage 14.

The ROM 12 stores various programs and various types of data. The RAM 13 temporarily stores programs or data as a working area. The storage 14 is configured as a hard disk drive (HDD) or a solid state drive (SSD) and stores various programs including an operating system and various types of data.

The input unit 15 includes a pointing device such as a mouse, and a keyboard and is used to perform various inputs.

The display unit 16 may be, for example, a liquid crystal display and display various types of information. The display unit 16 may employ a touch panel and serve as the input unit 15.

The communication interface 17 is an interface for communicating with other devices such as a terminal and, for example, standards such as the Internet (registered trademark), FDDI, and Wi-Fi (registered trademark) may be used.

Next, each functional configuration of the conversion learning apparatus 100 will be described. Each functional configuration is realized by the CPU 11 reading the conversion learning program stored in the ROM 12 or the storage 14, developing the conversion learning program in the RAM 13, and executing the conversion learning program.

The input unit 101 receives at least one pair of a learning image x and attribute position information i representing an attribute of each position of the learning image. Specifically, the learning image x is a tensor having a size of “horizontal width×vertical width×number of channels”, and it is assumed that the horizontal width of the learning image x is W, the vertical width thereof is H, and the number of channels thereof is D here. In addition, the learning image x may be any tensor having a horizontal width and a vertical width which are identical, that is, W=H. Further, coordinates of the leftmost top side of the tensor are denoted by (0, 0, 0), and coordinates corresponding to a channel that is w to the right from the leftmost top side, h downward from the leftmost top side and d to the back are denoted by (w, h, d).

In addition, with respect to each tensor, a dimension of the horizontal width is represented by dimension 1, a dimension of the vertical width is represented by dimension 2, and a dimension of the number of channels is represented by dimension 3 for simple description. That is, the size of dimension 1 of x is W, the size of dimension 2 thereof is H, and the size of dimension 3 thereof is D.

Any method of generating an image having a horizontal width and a vertical width which are identical (W=H) from an image having a horizontal width and a vertical width which are different (W≠H) may be employed if it is processing of changing a size of a tensor. For example, resizing processing, cropping processing of cutting a part of an image, padding processing of repeatedly adding a numerical value of 0 or pixels of an edge of an image to the circumference of the image, mirroring processing of vertically or horizontally reversing and adding pixels of an edge of an image, or the like may be performed.

Each piece of attribute position information i has an attribute associated with each region obtained by dividing a learning image. An attribute may be any word representing a predefined characteristic of an image converted through the conversion learning apparatus 100. For example, the attribute may be a word representing a characteristic such as a color such as red or blue, a material such as wood or glass, or a pattern such as a dot or a stripe. In addition, an identifiable identification is assigned to each attribute. For example, when there are A types of predefined attributes, natural numbers of equal to or greater than 0 and less than A are assigned.

That is, the attribute position information i corresponds to a tensor I having a size of M×N×A when there are A types of attributes, and 1≤M≤W and 1≤N≤H when the size of a learning image x is W×H×D and thus M=N.

When the horizontal width of the learning image x is divided into M grids, the vertical width thereof is divided into N grids, and a numerical value that identifies an attribute of a grid that is an m-th grid to the right from the leftmost top and an n-th grid downward from the leftmost top with respect to the learning image x is a, 1 is disposed at positions of (m, n, a) of the tensor I. On the other hand, when the grid does not have the attribute identified by the numerical value a, 0 is disposed at the positions of (m, n, a) of the tensor I.

The input unit 101 transfers the received at least one pair of the learning image x and the attribute position information i to the mask generation unit 103.

The storage unit 102 stores two types of neural networks of a converter and an identifier and parameters of the neural networks. Hereinafter, description with respect to the storage unit 102 may be simplified on the premise that the converter and the identifier stored in the storage unit 102 are used.

The mask generation unit 103 generates an attribute mask y from the attribute position information i. In addition, the mask generation unit 103 generates, on the basis of the attribute position information i and an output from the identifier when the learning image x has been input thereto, an original attribute mask y^{o} and a target attribute mask y^{t} according to the output from the identifier. The original attribute mask y^{o} has the same size as the attribute mask y and is mask information representing an attribute of each position of the learning image x and an attribute degree of the learning image. The target attribute mask y^{t} is mask information representing an attribute desired to be assigned to each position of a converted image of the learning image x and an attribute degree of the converted image.

Specific processing of the mask generation unit 103 will be described. The mask generation unit 103 extends the attribute position information i such that the sizes of dimensions 1 and 2 become identical to the learning image x and generates the attribute mask y. As a method of extending the attribute position information i, any method of extending the attribute position information i while maintaining values in a tensor as binary value of 0 or 1 may be employed, and a nearest neighbor interpolation method may be used, for example.

Next, the mask generation unit 103 generates the original attribute mask y^{o} and the target attribute mask y^{t} in which the sizes of dimensions 1 and 2 are identical to those of the learning image x using the learning image x, the attribute position information i, and the identifier.

The original attribute mask y^{o} may be any tensor representing the attribute of each position of the learning image x and an attribute degree. For example, the learning image x may be input to the identifier, an attribute of each position of the input image may be identified, and a tensor having the same size as the attribute position information i may be output. The output tensor may be paired with the attribute position information i to generate original attribute position information i^{o}, and a tensor obtained by extending this original attribute position information i^{o} to the image size may be used as the original attribute mask y^{o}.

The target attribute mask y^{t} may be any tensor representing an attribute desired to be assigned to each position of a converted image and a degree of the attribute. For example, a certain channel of the original attribute mask y^{o} may be replaced by another certain channel to generate the target attribute mask y^{t}. For example, if a color is changed, a red channel of the original attribute mask y^{o} may be replaced by a blue channel.

In this manner, the mask generation unit 103 outputs the learning image x, the attribute mask y, the original attribute mask y^{o}, and the target attribute mask y^{t} to the image conversion unit 104.

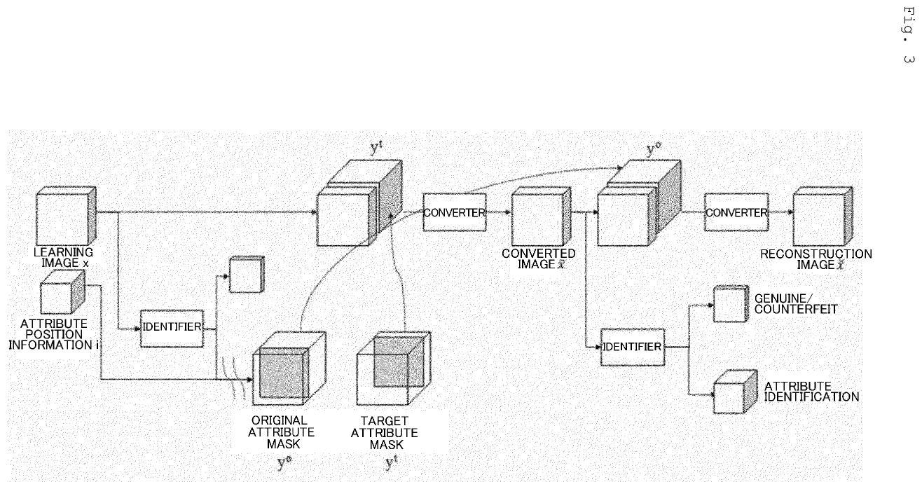

Here, FIG. 3 illustrates a relationship between the converter and the identifier in conversion learning processing.

The converter is a neural network that uses, as an input, a tensor obtained by superposing a tensor having the same size as the attribute mask y on the learning image x (or an image having the same size as the learning image x) in a direction of dimension 3. As the neural network, any neural network that generates, from this input, an image having the same size as the learning image x and attribute information assigned by the attribute mask y with respect to each position may be used. For example, when the size of the learning image x is 256×256×3 and the size of the attribute mask y is 256×256×10, if a tensor having a size of 256×256×13 is received as an input, an image having a size of 256×256×3 is output.

The identifier is a neural network that uses the learning image x (or an image having the same size as the learning image x) as an input. From this input, the neural network identifies whether each position of the learning image x is genuine or counterfeit, outputs a tensor having less sizes of dimensions 1 and 2 than the learning image x and a size of dimension 3 of 1, identifies an attribute of each position of the learning image x, and outputs a tensor having the same size as the attribute position information i. Any neural network having such outputs may be used. For example, it may be assumed that a tensor having a size of 256×256×3 is received as an input when the size of the learning image x is 256×256×3, the number of attributes is 10, and the size of the attribute position information i is 8×8×10. In this case, a tensor having a size of 8×8×1 for identifying whether each position of the learning image x is genuine or counterfeit and a tensor having a size of 8×8×10 for identifying an attribute of each position of the input image are output.

The image conversion unit 104 generates a converted image from an output from the converter using the learning image x and the target attribute mask y^{t} as inputs to the converter.

Specific processing of the image conversion unit 104 will be described. The image conversion unit 104 acquires the converter and parameters thereof from the storage unit 102. Subsequently, the image conversion unit 104 inputs a tensor obtained by superposing the target attribute mask y^{t} on the learning image x in the direction of dimension 3 to the converter and generates a converted image ˜x (˜x denotes x with symbol ˜ on top, the same applies hereinafter). The image conversion unit 104 outputs the learning image x, the converted image ˜x, the attribute mask y, the original attribute mask y^{o}, and the target attribute mask y^{t} to the parameter update unit 105.

The parameter update unit 105 updates parameters of the identifier and the converter on the basis of the learning image x, the converted image ˜x, the attribute mask y, the original attribute mask y^{o}, and the target attribute mask y^{t}.

First, update of the parameters of the identifier will be described. With respect to the identifier, the parameters of the identifier are updated such that the identifier identifies the learning image x as follows when the learning image x has been input to the identifier. Firstly, the parameters are updated such that the learning image x is correctly identified as having the attribute represented by the attribute mask y. Secondly, the parameters are updated such that the learning image x is identified as a genuine image. Thirdly, the parameters are updated such that the identifier identifies a converted image that has been converted from the learning image x as a counterfeit image when the converted image has been input to the identifier. The parameter update unit 105 updates the parameters of the identifier as described above.

Next, update of the parameters of the converter will be described. With respect to the converter, the parameters of the converter are updated such that conversion is performed as follows when the learning image x and the target attribute mask y^{t} have been input to the converter. Firstly, the parameters are updated such that the converted image ˜x to be generated by the converter has an attribute of each position represented by the target attribute mask to a degree represented by a numerical value of an attribute of each position of the converted image ˜x. Secondly, the parameters are updated such that the converted image ˜x is identified by the identifier as genuine. Thirdly, the parameters are updated such that the converter reconstructs the learning image x when the generated converted image ˜x and the original attribute mask y^{o} have been input to the converter. The parameter update unit 105 updates the parameters of the converter as described above.

The above-described update can be described as the following three types of restrictions. The parameter update unit 105 updates the parameters of the identifier and the converter such that the following three types of restrictions are satisfied.

The first restriction is a restriction of updating the parameters of the converter such that a reconstructed image \hat{ }x (\hat{ }x denotes x with sign \hat{ } on top, the same applies hereinafter) that is an output when the converted image ˜x and the original attribute mask y^{o} have been input to the converter reconstructs the learning image x. Any learning method that is set to satisfy this restriction may be employed, and in NPL 4, for example, a square error of the learning image x and the reconstructed image \hat{ }x is calculated and the parameters of the converter are updated such that the square error decreases.

The second restriction is divided into (A) and (B) below. (A) is a restriction that the identifier correctly identifies the learning image x as having the attribute represented by the attribute mask y when the learning image x has been input to the identifier. (B) is a restriction of updating each parameter of the converter such that the converted image ˜x has the attribute of each position represented by the target attribute mask y^{t} to a degree represented by the numerical value of each position of the converted image ˜x. Any learning method that is set to satisfy these restrictions (A) and (B) may be employed.

For example, with respect to (A), the parameters of the identifier are updated such that a probability of the identifier identifying an attribute of each position of the learning image x as an attribute of each position of the attribute mask y increases. On the other hand, with respect to (B), the converter updates the parameters of the converter such that a probability of an attribute of each position of the converted image ˜x being identified through an attribute of each position of the target attribute mask y^{t} and a value close to a numerical value of the attribute increases. That is, in a case where an attribute is a color, if the color of a certain position of the target attribute mask y^{t} is red, the parameters of the converter are updated such that a probability of a corresponding position of the converted image ˜x becoming red increases.

The third restriction is a restriction with respect to genuineness. This is a restriction of updating each parameter of the identifier and the converter such that the learning image x is identified by the identifier as genuine and the converted image ˜x is identified by the identifier as counterfeit, whereas the converted image ˜x output from the converter is identified by the identifier as genuine. Any learning method that is set to satisfy this restriction may be employed. For example, in NPL 4, the parameters of the identifier are updated such that a probability of the identifier identifying the learning image x as genuine and a probability of the identifier identifying the converted image ˜x as counterfeit increase. On the other hand, the converter updates the parameters of the converter such that a probability of the identifier identifying the converted image ˜x as genuine increases.

The parameter update unit 105 stores each parameter of the converter and the identifier trained to satisfy the above-described restrictions in the storage unit 102.

Meanwhile, in conversion learning processing, with respect to at least one pair of the input learning image x and attribute position information i, each parameter of the converter and the identifier may be trained for each pair or a plurality of parameters may be trained simultaneously or collectively through batch processing or the like.

<Configuration of Conversion Apparatus>

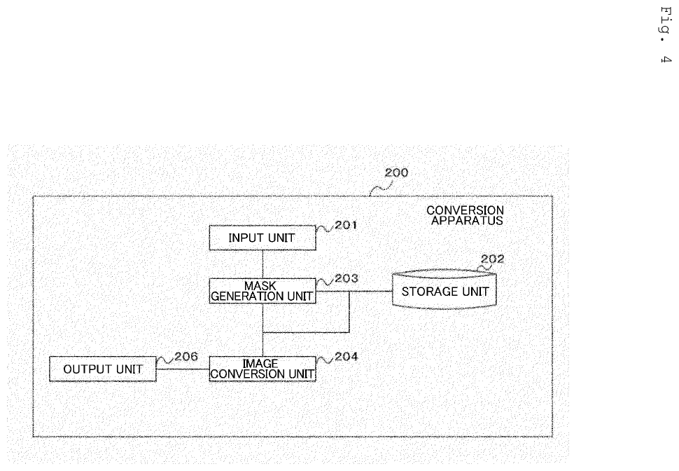

Next, a configuration of a conversion apparatus will be described. FIG. 4 is a block diagram illustrating a configuration of a conversion apparatus of the present embodiment.

As illustrated in FIG. 4, the conversion apparatus 200 includes an input unit 201, a storage unit 202, a mask generation unit 203, an image conversion unit 204, and an output unit 206.

Meanwhile, the conversion apparatus 200 can also be configured using the same hardware configuration as the conversion learning apparatus 100. As illustrated in FIG. 2, the conversion apparatus 200 includes a CPU 21, a ROM 22, a RAM 23, a storage 24, an input unit 25, a display unit 26, and a communication I/F 27. The components are connected through a bus 29 such that they can communicate with each other. The ROM 22 or the storage 24 stores a conversion program.

The input unit 201 receives an image x for conversion. Specifically, the image x for conversion is a tensor having a size of “horizontal width x vertical width x number of channels” and it is assumed that the horizontal width of the image x for conversion is W, the vertical width thereof is H, and the number of channels thereof is D here. In addition, the image x for conversion may be any tensor having a horizontal width and a vertical width which are identical, that is, W=H. Further, coordinates of the leftmost top side of the tensor are denoted by (0, 0, 0), and coordinates corresponding to a channel that is w to the right from the leftmost top side, h downward from the leftmost top side and d to the back are denoted by (w, h, d).

In addition, with respect to each tensor, a dimension of the horizontal width is represented by dimension 1, a dimension of the vertical width is represented by dimension 2, and a dimension of the number of channels is represented by dimension 3 for simple description as in conversion learning processing. That is, the size of dimension 1 of the conversion image x is W, the size of dimension 2 thereof is H, and the size of dimension 3 thereof is D.

Any method of generating an image having a horizontal width and a vertical width which are identical (W=H) from an image having a horizontal width and a vertical width which are different (W≠H) may be employed if it is processing of changing a size of a tensor. For example, resizing processing, cropping processing of cutting a part of an image, padding processing of repeatedly adding a numerical value of 0 or pixels of an edge of an image to the circumference of the image, mirroring processing of vertically or horizontally reversing and adding pixels of an edge of an image, or the like may be performed.

The input unit 201 transfers the received image x for conversion to the mask generation unit 203.

The storage unit 202 stores a converter and an identifier trained according to conversion learning processing of the conversion learning apparatus 100 and each parameter thereof.

The converter and the identifier are trained as follows on the basis of a learning image, a converted image that has been converted from the learning image, an attribute mask with respect to the learning image, an original attribute mask with respect to the learning image, and a target attribute mask with respect to the learning image. Meanwhile, the attribute mask is mask information generated from attribute position information representing an attribute of each position of the learning image.

With respect to the identifier in the storage unit 202, parameters of the identifier are updated such that identification is performed as follows. Firstly, the parameters are updated such that, when a learning image has been input to the identifier, the identifier correctly identifies the learning image as having an attribute represented by an attribute mask. Secondly, the parameters are updated such that the learning image is identified as a genuine image. Thirdly, the parameters are updated such that, when a converted image that has been converted from the learning image has been input to the identifier, the identifier identifies the converted image as a counterfeit image. The identifier is trained such that the parameters of the identifier are updated as described above.

With respect to the converter in the storage unit 202, parameters of the converter are updated such that conversion is performed as follows. Firstly, the parameters of the converter are updated such that, when a learning image and a target attribute mask have been input to the converter, a converted image to be generated by the converter has an attribute of each position represented by the target attribute mask to a degree represented by a numerical value of an attribute of each position of the converted image. Secondly, the parameters of the converter are updated such that the converted image is generated to be identified by the identifier as genuine. Thirdly, the parameters of the converter are updated such that, when the generated converted image and an original attribute mask has been input to the converter, the converter reconstructs the learning image. The converter is trained such that the parameters of the converter are updated as described above.

The mask generation unit 203 uses the image x as an input to an identifier trained in advance and stored in the storage unit 202 and generates an original attribute mask y^{o} and a target attribute mask y^{t} according to an output from the identifier. The original attribute mask y^{o} is mask information representing an attribute of each position of the image x and an attribute degree of the image. The target attribute mask y^{t} is mask information representing an attribute desired to be assigned to each position of a converted image of the image x and an attribute degree of the converted image.

The image conversion unit 204 uses the image x and the target attribute mask y^{t} as inputs to a converter trained in advance and stored in the storage unit 202 and generates a converted image ˜x according to an output from the converter. Meanwhile, the image conversion unit 204 may use the generated converted image ˜x and the original attribute mask y^{o} as inputs to the converter and generate a reconstructed image \hat{ }x. It is possible to check whether conversion is appropriately performed through the reconstructed image \hat{ }x.

The output unit 206 outputs the converted image ˜x generated by the image conversion unit 204 to the outside.

<Operation of Conversion Learning Apparatus>

Next, the operation of the conversion learning apparatus 100 will be described.

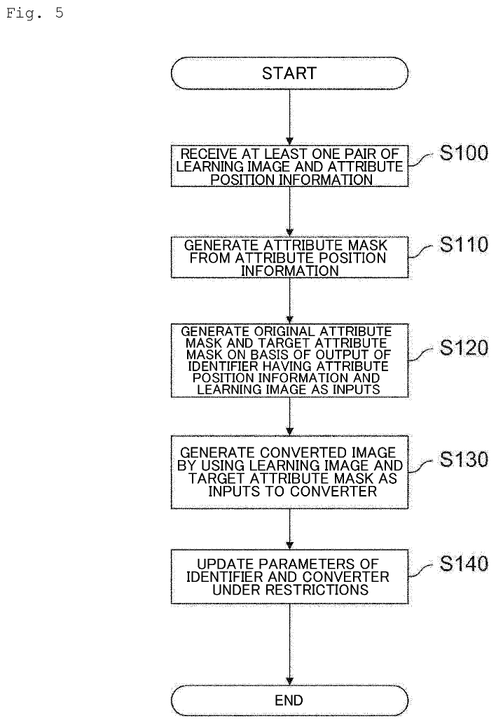

FIG. 5 is a flowchart illustrating a flow of conversion learning processing of the conversion learning apparatus 100. The conversion learning processing is performed by the CPU 11 reading the conversion learning program from the ROM 12 or the storage 14, developing the conversion learning program in the RAM 13, and executing the conversion learning program.

In step S100, the CPU 11 receives at least one pair of a learning image x and attribute position information i representing an attribute of each position of the learning image.

In step S110, the CPU 11 generates an attribute mask y from the attribute position information i.

In step S120, the CPU 11 generates an original attribute mask y^{o} and a target attribute mask y^{t} on the basis of an output from the identifier when the attribute position information i and the learning image x are used as inputs.

In step S130, the CPU 11 generates a converted image ˜x according to an output from the converter by using the learning image x and the target attribute mask y^{t} as inputs to the converter.

In step S140, the CPU 11 updates the parameters of the converter and the identifier under the aforementioned restrictions on the basis of the learning image x, the converted image ˜x, the attribute mask y, the original attribute mask y^{o}, and the target attribute mask y^{t}.

As described above, according to the conversion learning apparatus 100 of the present embodiment, learning for appropriately converting even an image including an unknown object can be performed.

<Operation of Conversion Apparatus>

Next, the operation of the conversion apparatus 200 will be described.

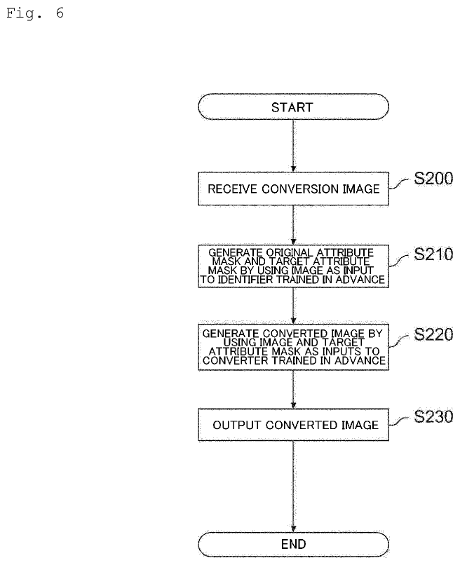

FIG. 6 is a flowchart illustrating a flow of conversion processing of the conversion apparatus 200. The conversion processing is performed by the CPU 21 reading the conversion program from the ROM 22 or the storage 24, developing the conversion program in the RAM 23, and executing the conversion program.

In step S200, the CPU 21 receives an image x for conversion.

In step S210, the CPU 21 uses the image x as an input to an identifier trained in advance and stored in the storage unit 202 and generates an original attribute mask y^{o} and a target attribute mask y^{t} according to an output from the identifier.

In step S220, the CPU 21 uses the image x and the target attribute mask y^{t} as inputs to a converter trained in advance and stored in the storage unit 202 and generates a converted image ˜x according to an output from the converter.

In step S230, the CPU 21 outputs the converted image ˜x generated in step S220 to the outside.

As described above, according to the conversion apparatus 200 of the present embodiment, even an image including an unknown object can be appropriately converted.

In addition, a conversion position and a conversion degree can be broadly estimated, a conversion position and a conversion degree can be adjusted during conversion, and even when an object image that is a conversion target is an unknown object that is not present in a learning image, an object image having a desired attribute can also be generated.

Meanwhile, conversion learning processing and conversion processing performed by a CPU reading and executing software (programs) in the above-described embodiment may be executed by various processors other than the CPU. In this case, as processors, dedicated electronic circuits that are processors having circuit configurations exclusively designed to execute specific processing, such as a programmable logic device (PLD) and an application specific integrated circuit (ASIC) having circuit configurations that can be modified after manufacture, such as a field-programmable gate array (FPGA), and the like are exemplified. In addition, the conversion learning processing and the conversion processing may be executed by one of these various processors or executed by a combination of two or more processors of the same type or different types (e.g., a combination of a plurality of FPGAs, a combination of a CPU and an FPGA, or the like). Furthermore, hardware structures of these various processors are, more specifically, electronic circuits in which circuit elements such as semiconductor elements are combined.

In addition, although an aspect in which the conversion learning program is stored (installed) in advance in the storage 14 has been described in each above-described embodiment, the present disclosure is not limited thereto. The program may be provided in a format stored in non-transitory storage media such as a compact disk read only memory (CD-ROM), a digital versatile disk read only memory (DVD-ROM), and a universal serial bus (USB) memory. Furthermore, the program may have a format downloaded from an external device through a network. The same applies to the conversion program.

The following supplement is disclosed with respect to the above-described embodiment.

(Supplement 1)

A conversion apparatus includes:

a memory; and

at least one processor connected to the memory,

the processor is configured to: receive an image for conversion;

use the image as an input to an identifier trained in advance and stored in a storage unit and generate a target attribute mask representing an attribute desired to be assigned to each position of a converted image of the image and an attribute degree of the converted image according to an output from the identifier; and

use the image and the target attribute mask as inputs to a converter trained in advance and stored in the storage unit and generate a converted image according to an output from the converter,

wherein the identifier and the converter are trained such that, on the basis of a learning image, a converted image converted from the learning image, an attribute mask generated from attribute position information representing an attribute of each position of the learning image, an original attribute mask having the same size as the attribute mask and representing the attribute of each position of the learning image and an attribute degree of the learning image, and the target attribute mask with respect to the learning image, parameters of the identifier are updated such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, with respect to the identifier in the storage unit, and

parameters of the converter are updated such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, with respect to the converter in the storage unit.

(Supplement 2

A non-transitory storage medium storing a conversion program for causing a computer to execute: receiving an image for conversion;

using the image as an input to an identifier trained in advance and stored in a storage unit and generating a target attribute mask representing an attribute desired to be assigned to each position of a converted image of the image and an attribute degree of the converted image according to an output from the identifier; and

using the image and the target attribute mask as inputs to a converter trained in advance and stored in the storage unit and generating a converted image according to an output from the converter,

wherein the identifier and the converter are trained such that, on the basis of a learning image, a converted image converted from the learning image, an attribute mask generated from attribute position information representing an attribute of each position of the learning image, an original attribute mask having the same size as the attribute mask and representing the attribute of each position of the learning image and an attribute degree of the learning image, and the target attribute mask with respect to the learning image, parameters of the identifier are updated such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, with respect to the identifier in the storage unit, and

parameters of the converter are updated such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, with respect to the converter in the storage unit.

### REFERENCE SIGNS LIST

100 Conversion learning apparatus
101 Input unit
102 Storage unit
103 Mask generation unit
104 Image conversion unit
105 Parameter update unit
200 Conversion apparatus
201 Input unit
202 Storage unit
203 Mask generation unit
204 Image conversion unit
206 Output unit

1. A conversion apparatus comprising circuitry configured to execute a method comprising:
receiving an input of an image for conversion;
generating, using the image as an input to an identifier trained in advance and stored in a storage, a target attribute mask representing an attribute desired to be assigned to each position of a converted image of the image and an attribute degree of the converted image according to an output from the identifier; and
generating, using the image and the target attribute mask as inputs to a converter trained in advance, in the storage and generates a converted image according to an output from the converter,
wherein the identifier and the converter are trained such that, on the basis of a learning image, a converted image converted from the learning image, an attribute mask generated from attribute position information representing an attribute of each position of the learning image, an original attribute mask having the same size as the attribute mask and representing the attribute of each position of the learning image and an attribute degree of the learning image, and the target attribute mask with respect to the learning image, parameters of the identifier are updated such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, with respect to the identifier in the storage, and
parameters of the converter are updated such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, with respect to the converter in the storage.

2. A conversion learning apparatus comprising:
receiving a learning image and attribute position information representing an attribute of each position of the learning image;
generating an attribute mask from the attribute position information;
generating an original attribute mask having the same size as the attribute mask and representing an attribute of each position of the learning image and an attribute degree of the learning image, and a target attribute mask representing an attribute desired to be assigned to each position of a converted image of the learning image and an attribute degree of the converted image on the basis of the attribute position information and an output from an identifier when the learning image has been input;
generating, using the learning image and the target attribute mask as inputs to a converter, a converted image according to an output from the converter; and
updating, with respect to the identifier, parameters of the identifier such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, and updates, with respect to the converter, parameters of the converter such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, on the basis of the learning image, the converted image, the attribute mask, the original attribute mask, and the target attribute mask.

3. The conversion learning apparatus according to claim 2, wherein restrictions in updating the parameters of the identifier include a restriction that the identifier updates the parameters of the identifier such that a probability of the attribute of each position of the learning image being identified as an attribute of each position of the attribute mask increases in update of the parameters of the identifier, and a restriction that the converter updates the parameters of the converter such that a probability of the attribute of each position of the converted image being identified through an attribute of each position of the target attribute mask and a value close to a value of the attribute increases in update of the parameters of the converter.

4. A computer-implemented method for converting an image, comprising:
receiving an image for conversion;
using the image as an input to an identifier trained in advance and stored in a storage unit and generating a target attribute mask representing an attribute desired to be assigned to each position of a converted image of the image and an attribute degree of the converted image according to an output from the identifier; and
using the image and the target attribute mask as inputs to a converter trained in advance and stored in the storage unit and generating a converted image according to an output from the converter,
wherein the identifier and the converter are trained such that, on the basis of learning image, a converted image converted from the learning image, an attribute mask generated from attribute position information representing an attribute of each position of the learning image, an original attribute mask having the same size as the attribute mask and representing the attribute of each position of the learning image and an attribute degree of the learning image, and the target attribute mask with respect to the learning image, parameters of the identifier are updated such that the identifier correctly identifies the learning image as having an attribute represented by the attribute mask and identifies the learning image as a genuine image when the learning image has been input to the identifier, and the identifier identifies the converted image converted from the learning image as a counterfeit image when the converted image has been input to the identifier, with respect to the identifier in the storage unit, and
parameters of the converter are updated such that a converted image to be generated by the converter has an attribute of each position represented by the target attribute mask of the learning image to a degree represented by a numerical value of an attribute of each position of the converted image and is generated to be identified by the identifier as genuine when the learning image and the target attribute mask of the learning image have been input to the converter, and the converter reconstructs the learning image when the generated converted image and the original attribute mask have been input to the converter, with respect to the converter in the storage unit.

5-7. (canceled)
